(19) United States
(12) Patent Application Publication
(10) Pub. No.: US 2013/0066480 A1
(43) Pub. Date: Mar. 14, 2013

(54) REAL-TIME MONITORING OF ELECTRIC POWER SYSTEM VOLTAGE STABILITY MARGINS

(71) Applicants: Mevludin Glavic, Raleigh, NC (US); Muhidin Lelic, Cary, NC (US); Damir Novosel, Cary, NC (US)

(72) Inventors: Mevludin Glavic, Raleigh, NC (US); Muhidin Lelic, Cary, NC (US); Damir Novosel, Cary, NC (US)

(73) Assignee: QUANTA ASSOCIATES, L.P

(21) Appl. No.: 13/607,496

(22) Filed: Sep. 7, 2012

Related U.S. Application Data
(60) Provisional application No. 61/531,923, filed on Sep. 7, 2011.

(51) Int. Cl. G05F 5/00

(52) U.S. Cl. 700/295; 700/286

(57) ABSTRACT

The disclosure relates to a method of detecting and managing voltage instability in power systems operations. The disclosed method identifies and follows Thevenin and load impedance values as they fluctuate in a power system using synchrophasor measurements. The values are recursively estimated and entered into calculations to identify stability margins through a simple P-Q plane representation to determine if load shedding is necessary.

### CROSS-REFERENCE TO RELATED APPLICATIONS

This application claims the benefit of U.S. Provisional Application No. 61/531,923 filed on Sep. 7, 2011.

### STATEMENTS REGARDING FEDERALLY SPONSORED RESEARCH OR DEVELOPMENT

Not applicable.

### NAMES OF PARTIES TO A JOINT RESEARCH AGREEMENT

Not applicable.

### BACKGROUND

Power system voltage instability is caused by inability of the combined generation and transmission system to deliver power requested by loads. Voltage stability is treated as a major threat for secure operation of the power system. In a voltage unstable situation, the voltage drops undergo a dramatic decline in the minutes following disturbance. If this decrease is too pronounced, the system integrity is endangered, mainly due to protecting devices that trip generation, transmission, or load equipment. This process may eventually lead to a blackout in a form of a voltage collapse [See Taylor, 1994, reference no. 13 in paragraph [0006]; see also Van Cutsem & Vournas, 1998, reference no. 14 in paragraph [0006]].

Power system disturbances are traditionally mitigated via protection and control actions, with objective to stop the power system degradation, restore the normal state, with minimization of impact of the disturbance. The control actions coupled with these mitigation means are not designed for a fast-developing disturbances and usually are too slow. This brings a very complex situation in front of the operators to deal with, where they rely on heuristic solutions and policies to apply the appropriate control actions.

Development of the Phasor Measurement Unit (PMU) technology in late 80's opened new perspectives in dealing with problems of voltage instability and this became an area of research since then. One of the topics was voltage instability detection. For reference to existing disclosure on voltage stability detection or assessment, please see:
1. J. Bertsch, M. Kaba, O. Lekva, “Method and Device for Assessing the Stability of an Electric Power Transmission Network”, U.S. Pat. No. 6,754,597 B1, Jun. 22, 2004.
2. H. D. Chiang, C. S. Wang, “Dynamic Method for Preventing Voltage Collapse in Electrical Power Systems”, U.S. Pat. No. 5,796,628, Aug. 18, 1998.
3. H. D. Chiang, H. Li, Y. Tada, T. Takazawa, Y. Yamada, A. Kurita, K. Koyanagi, “Group-Based BCU Methods for On-Line Dynamical Security Assessments and Energy Margin Calculations of Practical Power Systems”, U.S. Patent Application No. 2006/0190227 A1, Aug. 24, 2006.
4. C. C. Chu, S. H. Lee, H. C. Tsai, “Efficient Look-Ahead Load Margin and Voltage Profiles Contingency Analysis Using a Tangent Vector Index Method”, U.S. Patent Application No. 2006/0047370 A1, Mar. 2, 2006.
5. S. Corsi and G. N. Taranto, “A real-time voltage instability identification algorithm based on local phasor measurements,” IEEE Trans. Power Syst., vol. 23, no. 3, pp. 1271-1279, August 2008.
6. G. C. Ejebe, J. Tong, “Method for Voltage Stability Analysis of Power Systems”, U.S. Pat. No. 5,745,368, Apr. 28, 1998.
7. M. Glavic, T. Van Cutsem, “A Short Survey of Methods for Voltage instability Detection”, IEEE PES General Meeting, 2011.
8. M. H. Hague, “Determination of Steady-State Voltage Stability Limit Using P-Q Curve”, IEEE Power Engineering Review, pp. 71-72, April 2002.
9. M. Larsson, C. Rehtanz, and J. Bertsch, “Real-Time Voltage Stability Assessment of Transmission Corridors”, in Proc. IFAC Symposium on Power Plants and Power Systems, Seoul, S. Korea, 2003.
10.M. Larsson, C. Rehtanz, M Zima, “Determining Parameters for an Equivalent Circuit representing a Transmission Section of an Electrical Network”, U.S. Pat. No. 7,200,500 B2, Apr. 3, 2007.
11. W. H. Quaintance, J. Bertsch, “Method and Device for Assessing the Stability of and Electric Power Transmission Network”, U.S. Patent Application No. 2002/0123849 A1, Sep. 5, 2002.
12. C. Rehtanz, V. Burgler, J. Bertsch, “Stability Prediction for Electric Power Network”, U.S. Patent Application No. 2003/0040846 A, Feb. 27, 2003.
13. C. W. Taylor, Power System Voltage Stability, EPRI Power System Engineering Series, McGraw Hill, 1994.
14. T. Van Cutsem and C. Vournas, Voltage Stability of Electric Power Systems, Boston, Mass.: Kluwer, 1998,
15. K. Vu, M. M. Begovic, D. Novosel, and M. M. Saha, “Use of Local Measurements to Estimate Voltage-Stability Margin”, IEEE Trans. on Power Systems, vol. 14, no. 3, pp. 1029-1035, August 1999.
16. K. T. Vu and D. Novosel, “Voltage Instability Predictor (VIP): Method and System for Performing Adaptive Control to Improve Voltage Stability in Power Systems”, U.S. Pat. No. 6,219,591 B1, Apr. 17, 2001.
17. K. T. Vu, D. E. Julian, J. O. Gjerde, M. M. Saha, “Applications and Methods for Voltage Instability Predictor (VIP)”, U.S. Pat. No. 6,249,719 B1, Jun. 19, 2001.
18. L. Warland, “A Voltage Instability Predictor Using Local Area Measurements”, PhD Dissertation, The Norwegian University of Science and Technology, Trondheim, Norway, February 2002.
19. A. Wiszniewski, W. Rebizant, A. Klimek, “Method for Determining Voltage Stability Margin for Load Shedding Within an Electrical Power System”, U.S. Patent Application No. 2009/0009349 A1, Jan. 8, 2009.
20. P. Zhang, L. Min, N. Zhang, “Method for Voltage Instability Load Shedding Using Local Measurements”, U.S. Pat. No. 7,603,203 B2, Oct. 13, 2009.
21. P. Zhang, L. Min, J. Chen, “Measurement Based Voltage Stability Monitoring and Control”, U.S. Patent Application No. 2009/0299664 A1, Dec. 3, 2009.
22. A. Wiszniewski, W. Rebizant, A. Klimek, “Method of Determining Voltage Stability Margin for Load Shedding Within an Electrical Power System”, European Patent Application No. 2,079,143 A2, Jun. 30, 2008.
23. K. Iba, H. Suzuki, “Voltage Stability Discrimination System for Power Systems”, U.S. Pat. No. 4,974,140, Nov. 27, 1990.
24. R. Schlueter, “Method for Performing a Voltage Stability Security Assessment for a Power Transmission System”, U.S. Pat. No. 5,594,659, Jan. 14, 1997.
25. R. Schlueter, “Method for Improving Voltage Stability Security in a Power Transmission System”, U.S. Pat. No. 5,610,834, Mar. 11, 1997.
26. D. J. Kim, Y. H. Moon, H. Y. Kim, and Y. Yoon, “System and Method for Calculating Real-Time Voltage Stability Risk Index in Power System Using Time Series Data”, U.S. Pat. No. 7,236,898 B2, Jun. 26, 2007.
27. W. Li, P. Choudhury, J. Sun, J. Yu, and Y. Wang, “Method and System for Real Time Identification of Voltage Stability Via identification of Weakest Lines and Buses Contributing to Power System Collapse”, U.S. Pat. No. 7,816,927 B2, Oct. 19, 2010.
28. S. Solyom, B. Lincoln, and A. Rantzer, “Power System”, U.S. Pat. No. 7,982,442 B2, Jul. 19, 2011.
29. M. L. Williams, “Method for Measuring Stability Margin at a Node of a Polyphase Power Grid”, U.S. Patent Application No. 2007/0241759, Oct. 18, 2007.
30. P. Zhang, L. Min, and N. Zhang, “Method for Voltage Instability Load Shedding Using Local Measurements”, U.S. Patent Application No. 2008/0086239 A1, Apr. 10, 2008.
31. Cornell Research Foundation, Inc., “Dynamic Method for Preventing Voltage Collapse in Electrical Power Systems”, International PCT Application No. WO 1996/033544 A1, Oct. 24, 1996.
   The disclosures of the above documents are hereby incorporated by reference.

### BRIEF SUMMARY

The following advantages may be achieved through practice of the disclosure:
1. The disclosure provides means to calculate the accurate parabolic P-Q curve in real-time.
2. The method takes advantage of fast sampling measurement devices, phasor measurement units, (PMUs) for measuring current and voltage waveforms that can provide, for example, ten to one-hundred and twenty (10-120) samples per second, enabling timely detection of changes in the electric power system. It is to be appreciated that the range of ten to one-hundred and twenty (10-120) samples per second can vary both above and below those numbers and depends upon the sampling rate of the particular commercially available PMUs or other measurement units used. The proposed method is capable of operating beyond this stated range, but the above range (10-120 samples per second) is used in the disclosure for simplicity purposes and should not limit the method to such rates. In addition to PMUs, the method is able to process data from Supervisory Control and Data Acquisition (SCADA), and both static and dynamic simulation outputs. SCADA is one example where data samples are taken at slower rates (one sample per every few seconds). In addition, SCADA is a type of data that is currently being used in present Energy Management Systems (EMS) at the Control Centers
3. It is easy to implement and it offers a simple and clear interpretation of its results.
4. The method is adaptive as it tracks the changes in the electric power system using recursive procedures for calculating the Thevenin and load equivalents.
5. The embodiment(s) are applicable for voltage instability problems at various network locations: local bus, physical transmission corridors, and load centers, at both transmission and distribution systems. This is achieved with algorithmic extensions, depending on specific needs of the user, e.g. system operator,
6. It can be implemented in both various hardware devices (e.g. substation protection & control devices) and Control Center software tools (e.g. for monitoring and controlling voltage stability).
7. The method is flexible to accommodate specific needs of system operators, such as not merely showing the stability boundary but further updating the P-Q boundary at a rate that is practical to system operators (i.e. at a real time rate or slower). The margins are computed and may be visualized (e.g. graphically) at this practical rate and thus the method is applicable for monitoring slow changes in daily system operations as well as to track faster changes during system dynamics.
8. It is capable of discriminating between Fault Induced Delayed Voltage Recovery (FIDVR) and rapidly developing voltages instability.

The disclosure describes a method, apparatus and program for real-time calculation and monitoring of voltage stability margin of the electric power system. Based on the measurements of phasor data, the P-Q curve is updated and the active, reactive and apparent power margins are calculated and monitored to provide the power system operator with real-time information about how close the system is to its stability limit. When the stability margin falls below a specified minimum value, a control action can be triggered to prevent the system from a collapse. Such art action can be load shedding or similar.

### BRIEF DESCRIPTION OF THE DRAWINGS

FIG. 1 is an illustration of a two-bus equivalent system.

FIG. 2 is a graph illustration of power margins in a P-Q plane showing reactive loading margin ΔQ_{loading} loading and active loading margin ΔP_{loading}.

FIG. 3 is an illustration of one simple system in which the method may be used consisting of a generation dominant area and a load dominant area connected through two long transmission lines.

FIG. 4 is a graph of the time evolution of the voltage magnitude in an unstable load center.

FIG. 5 is a graph of the time evolution of the reactive power margin in an unstable load center.

FIG. 6 is a graph of the load and voltage stability boundaries for five different time instants in an unstable load center.

FIG. 7 depicts a schematic view of an electrical system, according to one embodiment.

FIG. 8 depicts a block diagram of the electrical system monitoring and load shedding system.

FIG. 9 is a graph illustrating a typical FIDVR followed by a transmission network fault at 500 and 115 kV.

FIG. 10 is a graph illustrating the margins visualization in the P-Q plane corresponding to FIG. 9 at the 115 kV side for a typical FIDVR followed by a transmission network fault.

FIG. 11 is a depiction of one embodiment of a computer generated display of the method in real time.

FIG. 12 is a flowchart illustrating an embodiment of the method of monitoring voltage stability margins with load shedding.

### DETAILED DESCRIPTION OF EMBODIMENT(S)

The description that follows includes exemplary apparatus, methods, techniques, and/or instruction sequences that embody techniques of the inventive subject matter. However, it is understood that the described embodiments may be practiced without these specific details.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., hard disk); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wire line, wireless, or other communications medium.

Computer program code for carrying out operations of the embodiments may be written in any combination of one or more programming languages, including an object oriented programming language such as Java, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

The text below introduces a methods, steps, techniques, instruction sequences and/or apparatuses for real-time estimation of power margins (MVA, MW and Mvar) for an electric power system that has a sending (generating) and receiving (load) parts. This network is presented by a two-bus equivalent system. First part of the description (“Preliminaries”) provides theoretical foundation and the second part (“New Margin Derivation and Visualization”) provides the methods, steps, techniques, instruction sequences and/or apparatuses.

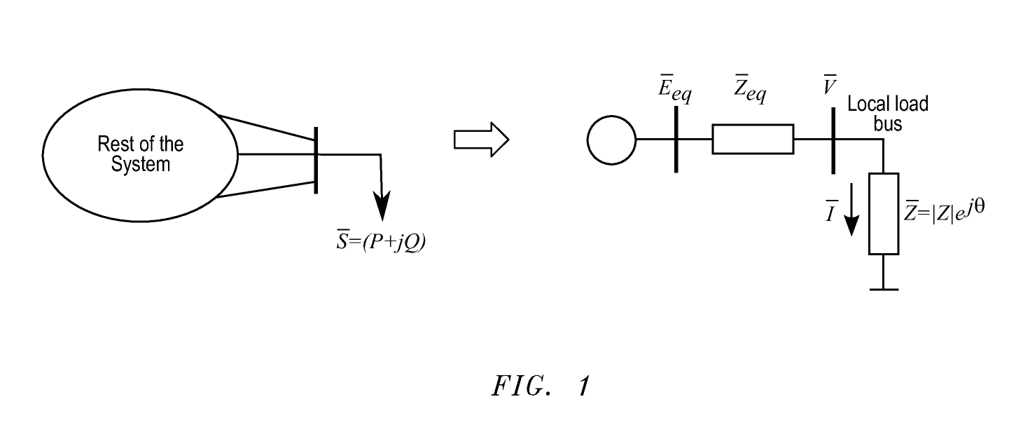

Preliminarily, the method is based on representing the system as a two-bus equivalent (impedance of the bus and equivalent Thevenin impedance and source that represent the rest of the system), as illustrated in FIG. 1 [See Taylor, 1994, reference no. 13 in paragraph [0006]; see also Van Cutsem & Vournas, 1998, reference no. 14 in paragraph [0006]].

From the electric circuits theory one can derive the following equations [See Taylor, 1994, reference no. 13 in paragraph [0006]; see also Van Cutsern & Vournas, 1998, reference no. 14 in paragraph [0006]]:

$$\begin{matrix}a . Current \text{:} \overline{I} = \frac{{\overline{E}}_{eq}}{( {R}_{eq} + R ) + j ( {X}_{eq} + X )} & ( 1 ) \\ b . Active power consumed by the load \text{:} P = {RI}^{2} = \frac{{RE}_{eq}^{2}}{{( {R}_{eq} + R )}^{2} + {( {X}_{eq} + X )}^{2}} & ( 2 )\end{matrix}$$

By maximizing P over R and X the necessary extreme conditions (maximum of active power consumed by the load) are

$$\frac{\partial P}{\partial R} = 0 \\ \frac{\partial P}{\partial X} = 0 \qquad ( 3 )$$

Leading to the following equations:

(R_{eq}+R)²+(X_{eq}+K)²−2R(R_{eq}+R)=0 (4)

−R(X_{eq}+X)=0 (5)

Since >0, the unique solution of the above equations is:

R_{eq}=R (6)

X_{eq}=−X (7)

or, in complex form:

Z̅_{eq}= Z̅* (8)

This theoretical condition is not applicable in real power systems for several reasons, and the most important are:
a. In most actual power systems R_{eq} is negligible. As R_{eq} is getting close to zero, optimal load resistance also goes to zero, thus resulting in the maximum power Pₘₐₓ=E_{eq}²/4R that tends to infinity and this is not realistic;
b. Even if R is not considered negligible, a highly capacitive load would be required to match highly inductive nature of power system impedance on the generation side.

To address the discrepancy described above, let's represent the reactive part of the impedance via resistance and the load power factor

X=R·tan θ (9)

In this case the following the active power consumed by load can be represented as:

$$P = \frac{{RE}_{eq}^{2}}{{( {R}_{eq + R} )}^{2} + {( {X}_{eq} + R \cdot tan θ )}^{2}} \qquad ( 10 )$$

The maximum value of this power is calculated from:

$$\frac{\partial P}{\partial R} = 0 \qquad ( 11 )$$

The above formula yields:

(R_{eq}²+X_{eq}²)−R²(1+tan² θ)=0 (12)

which is equivalent to:

| Z̅_{eq}|=| Z̅| (13)

The second derivative of the, power over load resistance results in:

$$\frac{{\partial }^{2} P}{\partial {R}^{2}} = - 2 R ( 1 + {tan}^{2} θ ) \qquad ( 14 )$$

The value of the derivative above is always negative, indicating that the solution represents a maximum.

The main challenge in the practical applications of above simple theory is identification of equivalent impedance Z̅_{eq}, due to the fact that this value changes over time. Several methods can be used to address this challenge:
a. Delta method [See Warland, 2002, reference no 18 in paragraph [0006]];
b. Cumulative sum method [See Warland, 2002, reference no. 18 in paragraph [0006]];
c. Recursive least-squares method [See Vu et. al, 1999, reference no. 15 in paragraph [0006]; see also Vu & Novosel, 2001, reference no. 16 in paragraph [0006]];
d. Separate identification of the equivalent's voltage and impedance [See Corsi & Taranto, 2008, reference no. 5 in paragraph [0006]].

### New Margin Derivation and Visualization

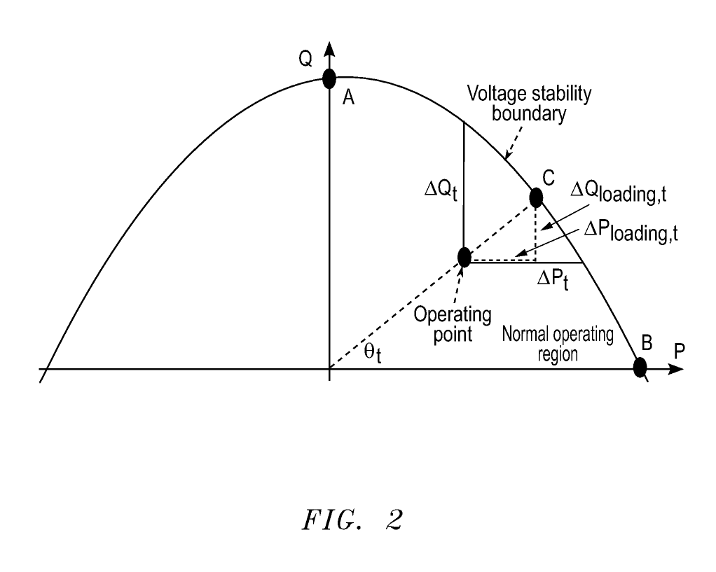

Power margins (MVA, MW, and Mvar) related to voltage instability problem proposed so far are loading margins. Computation of these margins is based on the assumption that the load power factor will be the same as currently measured. FIG. 2 illustrates the power margins on a P-Q plane, where reactive ΔQ_{loading} and active ΔP_{loading} margins are shown. These margins are derived from apparent power margin expressed in MVA that is computed from current measurements and identified equivalent's parameters.

The maximum MVA corresponding to current values of the equivalent parameters (at time instant t) is computed as,

$${S}_{max , t} = \frac{{\vert \overline{E} \vert}_{eq , t}^{2} \sqrt{1 + {tan}^{2} {θ}_{t}}}{2 ( {R}_{eq , t} + {X}_{eq , t} \cdot tan {θ}_{t} \pm \sqrt{( {R}_{eq , t}^{2} + {X}_{eq , t}^{2} ) ( 1 + {tan}^{2} {θ}_{t} )} )} \qquad ( 15 )$$

Assuming the voltage stability boundary is defined by a parabolic equation (this is a realistic assumption [See e.g. Taylor, 1994, reference no. 13 in paragraph [0006]; Van Cutsem & Vournas, 1998, reference no. 14 in paragraph [0006]; Warland, 2002, reference no. 18 in paragraph [0006]; Vu et al, 1999, reference no. 15 in paragraph [0006]; Vu & Novosel, 2001, reference no 16 in paragraph [0006]]),

Qₜ=aₜPₜ²+bₜPₜ+cₜ (16)

the problem becomes determination of the parabola coefficients a, b, and c. These coefficients are uniquely determined by points A, B, and C in FIG. 2. Coordinates of these points in P-Q plane are obtained as follows:

A: (0, Q_{max,t}) (17-a)

B: (P_{max,t}, 0) (17-b)

C: (S_{max,t}·cos θₜ, S_{max,t}·sin θₜ) (17-c)

The values of P_{max,t} and Q_{max,t} are derived as follows:

### Letting

$$tg {θ}_{t} = \frac{{x}_{t}}{{R}_{t}} \to 0$$

(only the active load power increase assumed) results in (from (13)):

$${P}_{max , t} = \frac{{E}_{eq , t}^{2}}{2 ( {R}_{eq , t} + \vert {Z}_{e , q , t} \vert )} , \qquad ( 18 )$$

For tgθₜ=Rₜ/Xₜ→∞ (only reactive load power increase assumed) from (13) one gets:

$$\begin{matrix}{Q}_{max , t} = \frac{{E}_{eq , t}^{2}}{2 ( {X}_{eq , t} + \vert {Z}_{eq , t} \vert )} \\ where & ( 19 ) \\ \vert {Z}_{eq , t} \vert = \sqrt{{R}_{eq , t}^{2} + {X}_{eq , t}^{2}} & ( 20 )\end{matrix}$$

In order to compute coefficients aₜ, bₜ, and cₜ a set of measurement data points taken within predefined time window should be used. Let the number of measurement is denoted by N. The coefficients a_{tN}, b_{tN}, and c_{tN} can be computed from the following set of over-determined linear equations

$$\vert \begin{matrix}0 & & & & 0 & 1 \\ {P}_{max , t 1}^{2} & & & & {P}_{max , t 1} & 1 \\ {( {S}_{max , t 1} \cdot cos {θ}_{t 1} )}^{2} & & & & {S}_{max , t 1} \cdot sin {θ}_{t 1} & 1 \\ & ⋮ & ⋮ & ⋮ & & \\ & ⋮ & ⋮ & ⋮ & & \\ 0 & & & & 0 & 1 \\ {P}_{max , t N}^{2} & & & & {P}_{max , t N} & 1 \\ {( {S}_{max , tN} \cdot cos {θ}_{t N} )}^{2} & & & & {S}_{max , t 1} \cdot sin {θ}_{t 1} & 1\end{matrix} \vert [ \begin{matrix}{a}_{tN} \\ {b}_{tN} \\ {c}_{tN}\end{matrix} ] = [ \begin{matrix}{Q}_{max , t 1} \\ 0 \\ {S}_{max , t 1} \cdot sin {θ}_{t 1} \\ ⋮ \\ ⋮ \\ {Q}_{max , t 1} \\ 0 \\ {S}_{max , t 1} \cdot sin {θ}_{tN}\end{matrix} ] \qquad ( 21 )$$

This set of over-determined linear equations is solved using least squares method. These equations can be presented in a compact form as,

A_{3N×3}x_{3×1}=d_{3N×1} (22)

And its solution is obtained by solving the following unconstrained optimization problem,

Min∥Ax−d∥₂ (23)

In principle, only one measurement sample (N=1) is sufficient to uniquely determine the coefficients aₜ, bₜ, and cₜ. In this case the set of linear equations (21) is solved directly. However, utilization of multiple data samples is useful in order to minimize impact of fast (and often temporary) system transients. Number of the samples can be determined by a user—however it is preferred that the coefficients aₜ, bₜ, and cₜ be refreshed at a rate lower than at every sampling interval. A good guidance can be one second interval, which means that the calculations will be conducted after every ten to one-hundred and twenty (10 to 120) samples are taken. This is based on the assumption that the PMUs are collecting phasor measurements at rates between 10 and 120 per second.

Once the coefficients aₜ, bₜ, and cₜ are determined, the active and reactive load power margins, at current time instant t, can be computed as,

ΔPₜ=P_{max,t}−Pₜ (24-a)

ΔQₜ=Q_{max,t}−Qₜ (24-b)

ΔSₜ=S_{max,t}−Sₜ (24-c)

where Pₜ and Qₜ are the values of load active and reactive powers measured at time instant t.
These computations can also be performed at every time instant when a new measurement sample is available. Thus, it accounts for changes in operating conditions but also in the voltage stability boundary. One possibility is to perform these calculations after every N measurements (N>1) and use the data received between these calculations either to perform a least square estimation of the required parameters, or to employ filtering techniques to help reducing the effects of noise and other fast disturbances that may occur in the system.

One preferred embodiment of the proposed innovative method for real-time calculation of power margin is presented in Algorithm 1 below. Those skilled in the art may recognize that variations of this algorithm are possible.

### Method Embodiment 1

### Real-Time Monitoring of Voltage Stability Margins

1. At time t:
   a. Calculate equivalent parameters Ē_{eq,t} and Z̅_{eq,t}
   b. Calculate the load impedance Z̅ₜ
2. Calculate P_{max,t}, Q_{max,t} and S_{max,t} from equations (18), (19), and (15), respectively
3. Calculate parameters aₜ, bₜ and cₜ of the parabola Q_{max,t}=aₜ·P_{max,t}²+bₜ·P_{max,t}+cₜ using equation (21) and least squares method (23)
4. Calculate the power margins ΔPₜ, ΔQₜ, ΔSₜ using equations (24)
5. Set t→t+1 and go to step 1.

Another preferred embodiment is to use the voltage stability margin in combination with load shedding. For this preferred embodiment, the description of this method is given below

### Method Embodiment 2

### Real-Time Monitoring of Voltage Stability Margins with Load Shedding

1. Set the threshold stability margins ΔPₘᵢₙ, ΔQₘᵢₙ, ΔSₘᵢₙ that will be used as a trigger point for load shedding initialization. It is assumed that only one of these three threshold values will be used as a trigger point for load shedding.
2. At time t:
   a. Calculate equivalent parameters Ē_{eq,t} and Z̅_{eq,t}
   b. Calculate the load impedance Z̅_{,t}
3. Calculate P_{max,t}, Q_{max,t} and S_{max,t} from equations (18), (19), and (15), respectively
4. Calculate parameters aₜ, bₜ and cₜ of the parabola Q_{max,t}=aₜ·P_{max,t}²+bₜ·P_{max,t}+cₜ using equation (21) and least squares method (23)
5. Calculate the power margins ΔPₜ, ΔQₜ, ΔSₜ using equations (24)
6. If selected margin is smaller than a threshold value (for instance: ΔPₜ<ΔPₘᵢₙ) start Load Shedding process; otherwise proceed to the next step, 7.
7. Set t→t+1 and go to step 1.

Various preferred embodiments are further listed below:
i. Monitoring of power margins at individual system buses (substations). In this case one measurement device is needed and located at the bus of concern. Further, the same principle can be extended to several system buses monitored individually.
ii. Transmission corridor margins monitoring. In this case each physical corridor should be monitored separately with measurement devices located at both ends of the corridor. The resulting margin is power (apparent, active, or reactive) that can be transmitted over the corridor (from sending to receiving end) before voltage stability limit is reached.
iii. Load center margin monitoring. This case is generalization of transmission corridor case. Each physical in-feed to the load center should be monitored separately with measurement devices located at both ends of the in-feed. Resulting margins are powers that can be delivered to the load center over particular in-feed. Further generalization is possible by aggregation of all physical in-feeds and their consideration as a virtual one. In this case the margins of whole load center can be computed and easily visualized.

### Illustrative Example

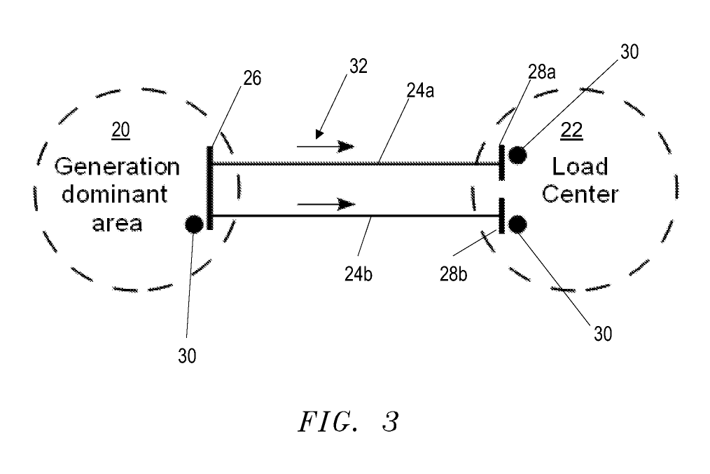

The method is illustrated using a simple load center configuration given in 3. The system consists of two areas: generation dominant area 20 and a load dominant area (load center) 22 connected through two long transmission lines 24a and 24b. The lines originate from the same bus 26 in generation dominant 20 area and they end in two separate, but electrically, close buses 28a and 28b in the load center 22. Locations for phasor measurement units 30 are shown in FIG. 3. These measurements are assumed to provide voltage magnitude and angle at the bus (26, 28a, and/or 28b) where they are located as well as current magnitude, current angle, active and reactive power flows on all lines incident to the bus of measurement locations. In this particular example, the measurements are provided every 0.033 seconds, which corresponds to thirty (30) synchrophasor data samples per second.

The voltage stability margins are computed in terms of power (apparent, active and reactive) that can be transmitted from the generation dominant area to the load center 22 over two transmission lines 24a and 24b considered as a transmission corridor 32. Parameters of the Thevenin's equivalent for the load center 22 are computed using the method of [Corsi & Taranto, 2008, reference no. 5 in paragraph [0006]] combined with the equivalent of transmission corridor 32 computed using method of [Larsson et al, 2007, reference no. 10 in paragraph [0006]].

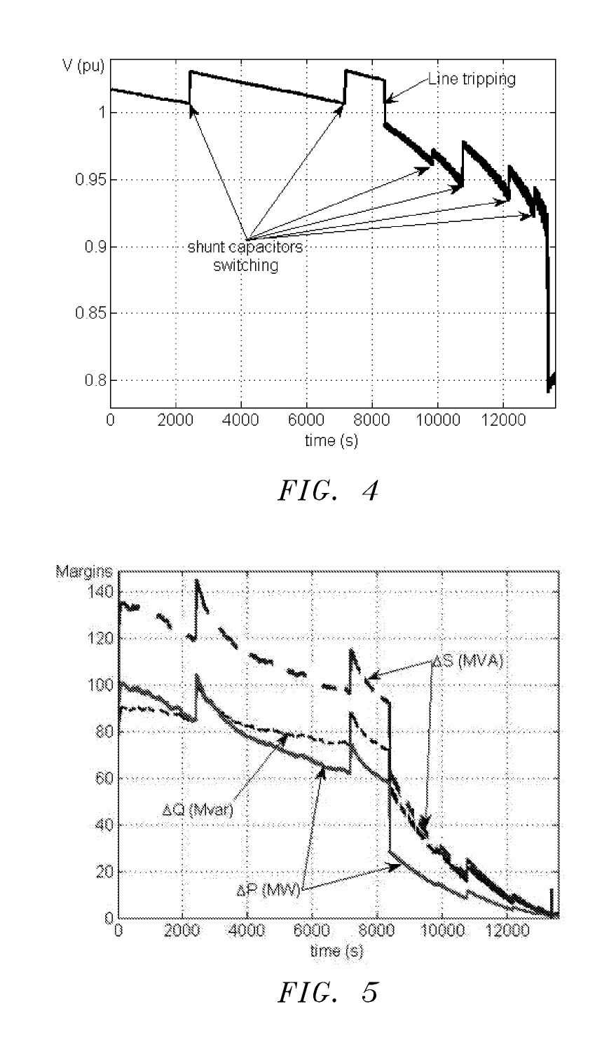

Particular case considered in this example is the load ramping in the load center 22 followed by a line tripping in the generation dominant area 20. Both generation dominant area 20 and load center 22 are equipped with shunt capacitors that are switched during specific scenario considered. The results are illustrated in terms of time evolution of a voltage magnitude at one of the load center buses (28a and/or 28b) in FIG. 4 and the time evolution of power margins for the load center in FIG. 5.

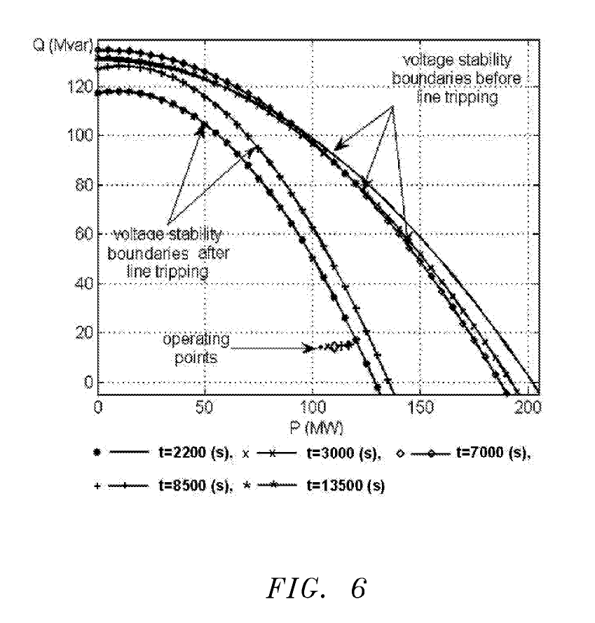

The event of the voltage collapse is described below:
1. The load ramping or linear load increase (assuming increase in both active and reactive load powers according to initial load power factors) in the load center 22 causes slow voltage magnitude decrease in the bus 28a and/or 28b within the load center 22.
2. At time instant of approximately 2200 seconds, a shunt capacitor is switched in the system in order to, improve voltage profile. The method described in this disclosure is not aware of where the shunt capacitor is located but it detects its impact by processing the phasor data from the phasor measurement device 30. This important voltage-related event is properly accounted for by the algorithm in the form of detection of the abrupt change (increase) in reactive power margin (see FIG. 5).
3. As seen from the FIG. 4, further load increase results in progressive voltage decrease and another shunt capacitor is switched at time instant of approximately 7000 (s). Again, this event is detected by the method described from this disclosure as a jump in the reactive power margin, FIG. 5.
4. Few hundred seconds after time instant of 8500 (s) a line was tripped by a protection device in the generation dominant area 20 (at the sending end of the system). This is properly accounted for by the method (a considerable decrease in reactive power margin is observed, see FIGS. 5 and 6).
5. After this, the system further evolves with several additional shunt capacitors switching trying to restore system voltages. System collapses at the time instant of 13500 (s) are shown in FIGS. 4, 5, and 6.

Determination of the voltage stability boundary in P-Q plane is performed for five points during the voltage collapse scenario described above (before and after line tripping in generation dominant area 20, revealed to be important system events having large impact on system stability conditions). The load and voltage stability boundaries for five different time instants, together with corresponding operating points are given in FIG. 6. During the development described above, the stability boundary curve shrinks causing the stability margin to gradually diminish leading to a voltage collapse.

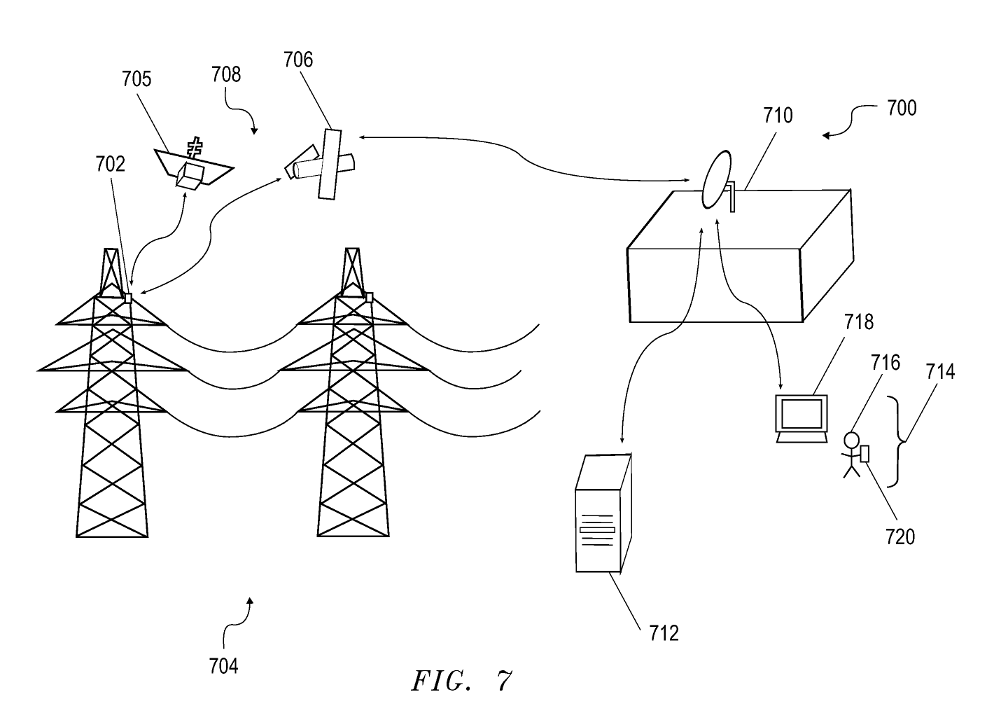

FIG. 7 depicts a schematic view of an electrical system 704, according to one embodiment.

Overhead receiving and communication system 700 in one embodiment encompasses the transmitting device 702 (which may be linked to a phasor measurement device 30) on electrical system 704 and may include a communication satellite 705, global-positioning satellite (or “GPS” satellite) 706, and/or a communication network 708. In one embodiment the communication network has a gateway 710, one or more computers or servers 712, and may include a power and/or service provider company 714 having operator or worker(s) 716 having their own computers 718, handheld (or other data input) devices 720, meaning any suitable data input devices including, but not limited to, a tablet computer, a personal digital assistant, a smart phone, a laptop, a desktop, any suitable data input device described herein and the like. The electrical system 704 may include transmission lines, transmission corridors, local bus centers, load centers, or any combination of the foregoing. The communication network 708 may be located at the transmission lines, transmission corridors, local bus centers, load centers, or any combination of the foregoing. It is to be understood as used herein, the terms “transmit”, “transmitter”, “receive”, “receiver” may be interchangeable or transmitting and receiving may be integrated into a single component as would be available to one having ordinary skill in the art.

The computer(s) 712, 718 and/or 720 may be a traditional desktop computer, or any other suitable computer including, but not limited to, a tablet, a laptop, a personal digital assistant and the like. The communication network 708 may be any suitable system for relaying data about the electrical system 704 including those described herein. The communication network 708 may include wires, wireless communication, acoustic communication, telemetry tools, and the like. The communication network 708 may be limited to relaying information about the electrical system 704. In an alternative embodiment, the communication network 708 may include an internet, or cloud communication network, and may be combined with the overhead receiving and communication system 700. The communication network 708 and/or the overhead receiving and communication system 700 may be any suitable network including those described herein.

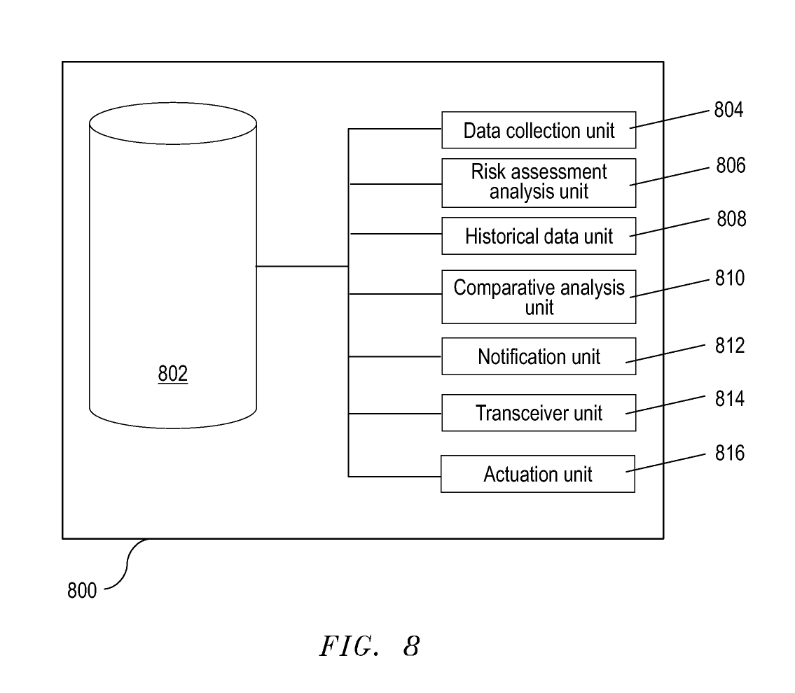

FIG. 8 depicts a block diagram of the electrical system monitoring and load shedding system 800 according to an embodiment. The electrical system monitoring and load shedding system 800 may have a storage device 802, a data collection unit 804, a risk assessment analysis unit 806, a historical data unit 808, a comparative analysis unit 810, a notification unit 812, a transceiver unit 814, and an actuation unit 816. The storage device 802 may be any suitable storage device for storing data The transceiver unit 814 may be any suitable device configured to send and/or receive data to the electrical system monitoring, management and load shedding system 800.

The data collection unit 804 may collect, manipulate, and/or categorize the data collected by broadly any data collected by the communication network 708 and/or the overhead receiving and communication system 700. The data collected may include any of the real time details of any and all of the transmitting devices 702 on and/or off the electrical system 704. Further, the data collected may be any suitable data that can be collected from any suitable sensor including those described herein, laser scanners, acoustic tools, cameras, GPS devices, surveying equipment, weather condition sensors, and the like. The data collection unit 804 may manipulate the collected data into a format that allows the operator or worker 716 and/or actuation unit 816 to take appropriate action during the operations as discussed herein.

The risk assessment analysis unit 806 may receive the categorized data from the data collection unit 804 in order to tabulate and/or determine if there is any present or future risk likely at the electrical system 704. The risk may be based on real time events that are taking place in the operations and/or based on predictive events that are likely to occur. The risk assessment analysis unit 806 may classify the risks for electrical system 704.

The historical data unit 808 may categorize the historical data collected by the data collection unit 804. Further, the historical data unit 808 may categorize historical known data from the electrical system 704 such as consumer energy use patterns, geological factors, weather patterns and the like.

The comparative analysis unit 810 may compare the data collected by the data collection unit 804, the classified risks, and/or the historical data in order to determine a course of action. The comparative analysis unit 810 may further determine if the operations of the electrical system 704 are within a predetermined set of parameters. For example, should the voltage stability or power margins fall, the comparative analysis unit 810 may compare these conditions to calculated minimum thresholds or, in the alternative, to continue monitoring electrical system 704 to ensure that electrical system 704 is operating within stable voltage or power margins. The minimum thresholds may be calculated from an algorithm or set by the power company, regulatory agency, or any other suitable source. The comparative analysis unit 810 may make a determination of how serious the risk is based on the data collected. The comparative analysis unit 810 may relay information to the notification unit 812 so that the notification unit 812 may alert any operator or actuation unit 816 to take action. The comparative analysis unit 810 may use an algorithm to approximate or predict the voltage stability margins, and may include data gathered by the communication satellite 705, the GPS satellite 706 and/or transceiver device 702.

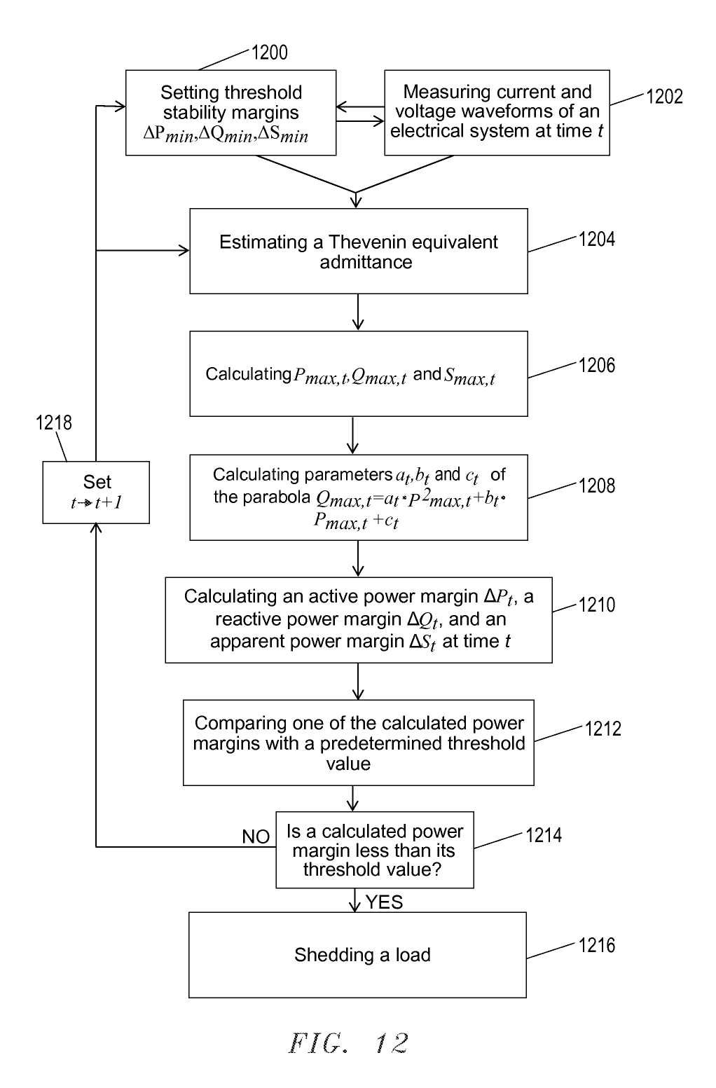

The notification unit 812 may alert any operator or actuation unit 816 of a real time condition (e.g. see FIG. 11), and/or a predicted condition about the electrical system 704. The notification unit 812 may alert the operator 716 or actuation unit 816 via a discrete alarm, a visual display, an audible sound (such as an alarm), a kinetic, electric or automated response, and/or a combination thereof. The notification unit 812 may transmit an alarm to the power company 714 via the communication network(s) 708. The notification unit 812 may create or enable an implementation plan. The implementation plan may include, but is not limited to recovery plans and schedules, maintenance plans and schedules, mitigation plans and schedules for any of the components of the electrical system 704 or the electrical system monitoring and load shedding system 800. Further, the notification unit 812 may take preventative action to prevent further risk to electrical system 704. For example, the notification unit 812 may initiate load shedding or line dropping in electrical system 704 to maintain system integrity.

The actuation unit 816 may access data from the data collection unit 804 and/or the risk assessment analysis unit 806 to determine the load shedding is required. When the actuation unit 816 determines that the voltage stability or power margins of electrical system 704 are less than the minimum thresholds, the actuation unit 816 may initiate the load shedding process. Load shedding decreases the demand on the electrical system 704 and operates to restore stability to the electrical system 704. The actuation unit 816 may determine the amount of load shedding required. For example, the actuation unit 816 may have predetermined voltage amounts that may be shed. In another embodiment, the operator and/or a worker 716 in a power company 714 may instruct the actuation unit 816 to initiate load shedding on command.

In an additional embodiment, the actuation unit 816 may determine when to initiate load shedding based on the environmental data in the electrical system 704. For example, the actuation unit 816 may receive data regarding energy use, weather geomagnetic or other relevant conditions in the electrical system 704. The actuation unit 816 may then initiate load shedding in response to these conditions.

The actuation unit 816 may use any suitable criteria including any combination of those described herein for determining the time interval and the amount of load shedding to initiate.

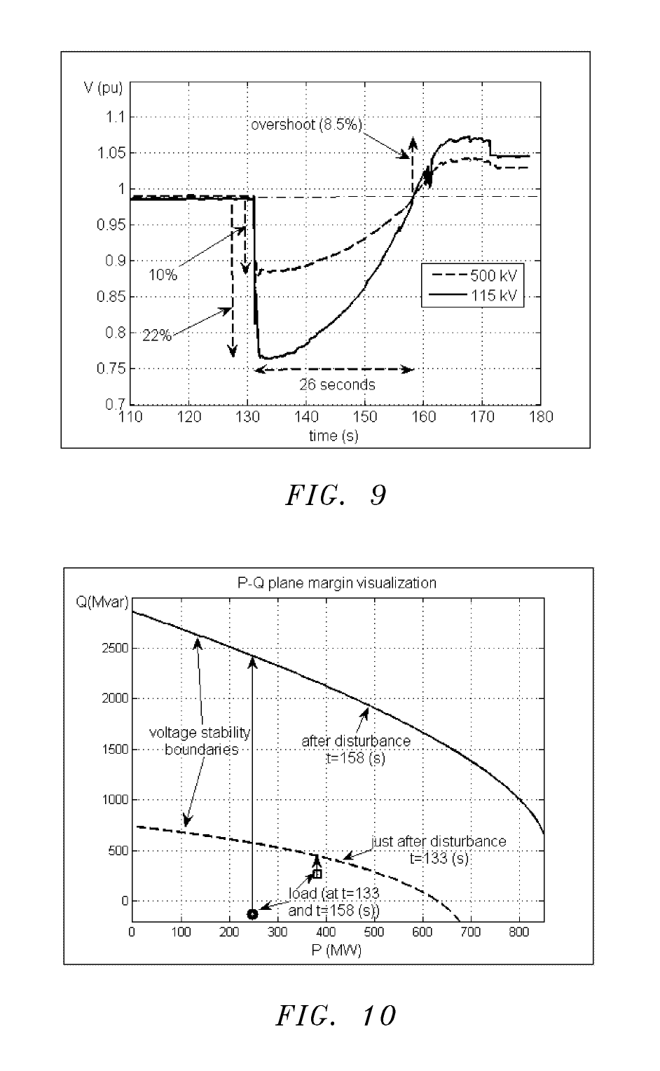

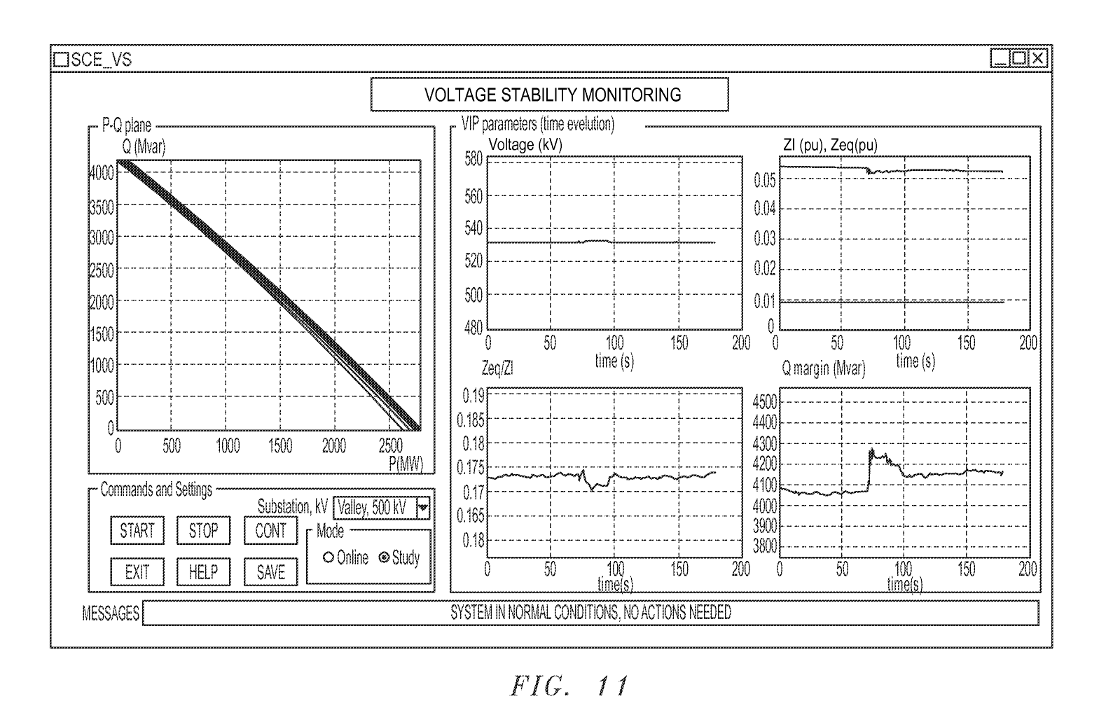

FIDVR is a phenomenon wherein the system voltage remains at significantly reduced levels for several seconds (or tens of seconds) after a transmission, subtransmission, or distribution fault has been cleared. A typical FIDVR followed by a transmission network fault in an electrical system is illustrated in FIG. 9 (substation with: 500 and 115 kV). Margins visualization in the P-Q plane is presented in FIG. 10 and corresponds to the substation's 115 kV side. The voltage stability boundaries and the loads are computed for two time instants: t=133 seconds, right after the disturbance occurred, and t=158 seconds, when reactive power margin recovered to a high value. The stability boundaries and the load visualized in this way provide indication of a dangerous situation approaching (reactive margin dropped below 200 Mvar, but the system preserved its stability). FIDVR and voltage instability can cause catastrophic electrical power system outages and incur significant economic and social costs. The proposed method mitigates these conditions to maintain electrical system stability.

FIG. 11 depicts one embodiment of a real-time version of the method, as seen as a computer generated screen display.

FIG. 12 is a flowchart illustrating an embodiment of the method of monitoring voltage stability margins with load shedding. The flow starts at block optionally at 1200, where threshold stability margins ΔPₘᵢₙ, ΔQₘᵢₙ, ΔSₘᵢₙ are set, or at block 1202, where current and voltage waveforms in an electrical system are measured. After block 1200 and/or 1202 is completed, the flow may continue at the other block, or continue to block 1204. At block 1204, a Thevenin equivalent admittance is estimated. The flow continues at block 1206, where P_{max,t}, Q_{max,t} and S_{max,t} is calculated. The flow then continues at block 1208, where parameters aₜ, bₜ and cₜ of the parabola Q_{max,t}=aₜ·P_{max,t}²+bₜ·P_{max,t}+cₜ are calculated. The flow continues at block 1210, where an active power margin ΔPₜ, a reactive power margin ΔQₜ, and an apparent power margin ΔSₜ at time t are calculated. At block 1212, the calculated power margins from block 1210 are compared to threshold stability margin values set in block 1200. In block 1214, if the calculated power margin is less than the threshold value, the flow continues to block 1216. In block 1216, voltage load shedding occurs. However, if in block 1214, the calculated power margin is not less than the threshold value, the flow continues to block 1218. At block 1218, time t is set to t+1, and the flow continues back to block 1200, 1202, or 1204.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method of monitoring voltage stability margins, comprising the steps of:
(a) measuring current and voltage waveforms of an electrical system selected from the group of electrical systems consisting of local system buses, transmission corridors, transmission lines, and load centers:
(b) estimating a Thevenin equivalent admittance based on maximizing P over R and X to find the maximum of active power consumed by the load, where P is the active power consumed by the load, R is the resistance, and X is the reactance;
(c) calculating P_{max,t}, Q_{max,t} and S_{max,t} where P_{max,t} is the maximum active power at time of measurement t, Q_{max,t} is the maximum reactive power at time of measurement t, and S_{max,t} is the maximum apparent power at time of measurement t;
(d) calculating parameters aₜ, bₜ and cₜ of the parabola Q_{max,t}=aₜ·P_{max,t}²+bₜ·P_{max,t}+cₜ;
(e) calculating an active power margin, a reactive power margin and an apparent power margin at time t.

2. The method of monitoring voltage stability margins according to claim 1, further comprising repeating all of the steps (a) through (e) at a time t+1 at a real time rate, and generating a graph of at least one of the active power margin, the reactive power margin and the apparent power margin in real time.

3. The method of monitoring voltage stability margins according to claim 2, wherein said step of generating the graph comprises generating the graph with at least two of the active power margin, the reactive power margin and the apparent power margin in real time.

4. The method of monitoring voltage stability margins according to claim 2, wherein said step of generating the graph comprises generating the graph with all three of the active power margin, the reactive power margin and the apparent power margin in real time.

5. The method of monitoring voltage stability margins according to claim 1, further comprising the step of
(a) shedding a load.

6. The method of monitoring voltage stability margins according to claim 2, further comprising the step of
(a) shedding a load.

7. The method of monitoring voltage stability margins according to claim 3, further comprising the step of
(a) shedding a load.

8. The method of monitoring voltage stability margins according to claim 1, further comprising the step of
(a) filtering to reduce effects of noise in the system.

9. The method of monitoring voltage stability margins according to claim 1, further comprising the step of
(a) filtering to reduce effects of fast moving disturbances in the system.

10. A method of monitoring voltage stability with load shedding, comprising the steps of:
(a) measuring current and voltage waveforms of an electrical system selected from the group of electrical systems consisting of local system buses, transmission corridors, transmission lines, and load centers;
(b) setting threshold stability margins ΔPₘᵢₙ, ΔQₘᵢₙ, ΔSₘᵢₙ that will be used as a trigger point for load shedding initialization, assuming that only one of these three threshold values will be used as a trigger point for load shedding, where ΔPₘᵢₙ is the minimum stability margin for the active power, ΔQₘᵢₙ is the minimum stability margin for the reactive power, and ΔSₘᵢₙ is the minimum stability margin for the apparent power margin.
(c) estimating a Thevenin equivalent admittance based on maximizing P over R and X to find the maximum of active power consumed by the load, where P is the active power consumed by the load, R is the resistance, and X is the reactance;
(d) calculating P_{max,t}, Q_{max,t} and S_{max,t} where P_{max,t} is the maximum active power at time of measurement t, Q_{max,t} is the maximum reactive power at time of measurement t, and S_{max,t} is the maximum apparent power at time of measurement t;
(e) calculating parameters aₜ, bₜ and cₜ of the parabola Q_{max,t}=aₜ·P_{max,t}²+bₜ·P_{max,t}+cₜ;
(f) calculating an active power margin, a reactive power margin and an apparent power margin at time t;
(g) comparing one of the calculated power margins with a predetermined threshold value; and
(h) utilizing the comparison between the one selected calculated power margin with the predetermined threshold value to determine whether to initiate a load shedding action.

11. The method of monitoring voltage stability margins according to claim 10, further comprising repeating all of the steps (a) through (h) at a time t+1 at a real time rate, and generating a graph of at least one of the active power margin, the reactive power margin and the apparent power margin in real time.

12. The method of monitoring voltage stability margins according to claim 11, wherein said step of generating the graph comprises generating the graph with at least two of the active power margin, the reactive power margin and the apparent power margin in real time.

13. The method of monitoring voltage stability margins according to claim 11, wherein said step of generating the graph comprises generating the graph with all three of the active power margin, the reactive power margin and the apparent power margin in real time.

14. The method of monitoring voltage stability according to claim 10, further comprising the step of
(a) filtering to reduce effects of noise in the system.

15. The method of monitoring voltage stability with load shedding according to claim 10, further comprising the step of
(a) filtering to reduce effects of fast moving disturbances in the system.

16. A method of monitoring voltage stability margins, comprising the steps of:
measuring current and voltage waveforms of an electrical system;
calculating a power margin selected from the group of power margins consisting of an active power margin, a reactive power margin and an apparent power margin at time t;
comparing one of the calculated power margins with a predetermined threshold value;
utilizing the comparison between the one selected calculated power margin with the predetermined threshold value to determine whether to shed a load;
repeating all of the foregoing steps at a time t+1 at a real time rate; and
generating a graph of at least one of the active power margin, the reactive power margin and the apparent power margin in real time.

17. The method of monitoring voltage stability margins according to claim 16, wherein said step of generating the graph comprises generating the graph with at least two of the active power margin, the reactive power margin and the apparent power margin in real time.

18. The method of monitoring voltage stability margins according to claim 16, wherein said step of generating the graph comprises generating the graph with all three of the active power margin, the reactive power margin and the apparent power margin in real time.

19. A system for monitoring voltage stability margins, comprising:
(a) an electrical system;
(b) a phasor measurement device connected to the electrical system;
(c) a global positioning satellite in communication with the phasor measurement device;
(d) a communication gateway in communication with the global positioning satellite;
(e) a computer in communication with the communication gateway;
(f) wherein the computer calculates a power margin and compares the calculated power margin with a predetermined threshold value acquired at a time t and then again at a time t+1 at a real time rate; and
(g) wherein the computer is configured to generate a graph in real time of at least one of the active power margin, the reactive power margin and the apparent power margin.

20. The system according to claim 12 wherein the computer further includes a notification unit including a means for shedding a load in the electrical system.
